(19) United States
(12) Patent Application Publication
(10) Pub. No.: US 2026/0371361 A1
(43) Pub. Date: Nov. 19, 2026

(54) RESOURCE ALLOCATION FOR DIFFERENT FRAME STRUCTURES IN SIDELINK COMMUNICATION

(71) Applicant: Nokia Technologies Oy, Espoo (FI)

(72) Inventors: Jianguo LIU, Shanghai (CN); Yong LIU, Shanghai (CN); Renato Barbosa ABREU, Aalborg (DK); Vinh VAN PHAN; Nuno Manuel KIILERICH PRATAS, Aalborg (DK); Timo Erkki LUNTTILA, Espoo (FI); Torsten WILDSCHEK, Gloucester (GB); Ling YU, Espoo (FI); Naizheng ZHENG, Beijing (CN); Laura Luque SANCHEZ, Aalborg (DK)

(21) Appl. No.: 19/103,145

(22) PCT Filed: Aug. 12, 2022
(86) PCT No.: PCT/CN2022/112313

§ 371 Date: Feb. 11, 2025

(51) Int. Cl. H04W 72/25; H04L 1/1607; H04W 74/0808

(52) U.S. Cl. CPC H04W 72/25; H04L 1/1614; H04W 74/0808

(57) ABSTRACT

Embodiments of the present disclosure relate to devices, methods, apparatuses and computer readable storage media of the resource allocation for different frame structures in sidelink communication. The method comprises in accordance with a determination that a first frame structure is allowed to be used in coexistence with a second frame structure in a slot for a sidelink communication, reserving a first set of resources for a first transmission using the first frame structure, the first set of resources being associated with a second set of resources reserved for a second transmission using the second frame structure; and transmitting an indication of the first set of resources and the second set of resources via at least one sidelink control channel. Based on the solution of the present disclosure, an efficient resource allocation solution for better support of coexistent full-slot and sub-slot frame structures for SL-U is achieved.

### FIELD

Embodiments of the present disclosure generally relate to the field of telecommunication and in particular to devices, methods, apparatuses, and computer readable storage media of the resource allocation for different frame structures in the sidelink communication.

### BACKGROUND

The support of sidelink on New Radio unlicensed spectrum (NR-U) has been studied as one of the interesting topics in the 3rd Generation Partnership Project (3GPP). The frame structure supporting a control channel or a data channel for the sidelink in NR-U needs to be further discussed.

### SUMMARY

In general, example embodiments of the present disclosure provide a solution of the resource allocation for different frame structures in the sidelink communication.

In a first aspect, there is provided a first device. The first device comprises at least one processor; and at least one memory storing instructions that, when executed by the at least one processor, cause the first device at least to in accordance with a determination that a first frame structure is allowed to be used in coexistence with a second frame structure in a slot for a sidelink communication, reserve a first set of resources for a first transmission using the first frame structure, the first set of resources being associated with a second set of resources reserved for a second transmission using the second frame structure; and transmit an indication of the first set of resources and the second set of resources via at least one sidelink control channel.

In a second aspect, there is provided a second device. The second device comprises at least one processor; and at least one memory storing instructions that, when executed by the at least one processor, cause the second device at least to determine whether a first frame structure is allowed to be used in coexistence with a second frame structure in a slot for a sidelink communication; and in accordance with a determination that the first frame structure is allowed to be used in the slot in coexistence with the second frame structure, determine at least a first set of resources reserved for a first transmission using the first frame structure and a second set of resources reserved for a second transmission using the second frame structure based on at least one sidelink control channel.

In a third aspect, there is provide a method. The method comprises in accordance with a determination that a first frame structure is allowed to be used in coexistence with a second frame structure in a slot for a sidelink communication, reserving a first set of resources for a first transmission using the first frame structure, the first set of resources being associated with a second set of resources reserved for a second transmission using the second frame structure; and transmitting an indication of the first set of resources and the second set of resources via at least one sidelink control channel.

In a fourth aspect, there is provide a method. The method comprises determining whether a first frame structure is allowed to be used in coexistence with a second frame structure in a slot for a sidelink communication; and in accordance with a determination that the first frame structure is allowed to be used in the slot in coexistence with the second frame structure, determining at least a first set of resources reserved for a first transmission using the first frame structure and a second set of resources reserved for a second transmission using the second frame structure based on at least one sidelink control channel.

In a fifth aspect, there is provided an apparatus comprising means for, in accordance with a determination that a first frame structure is allowed to be used in coexistence with a second frame structure in a slot for a sidelink communication, reserving a first set of resources for a first transmission using the first frame structure, the first set of resources being associated with a second set of resources reserved for a second transmission using the second frame structure; and means for transmitting an indication of the first set of resources and the second set of resources via at least one sidelink control channel.

In a sixth aspect, there is provided an apparatus comprising means for determining whether a first frame structure is allowed to be used in coexistence with a second frame structure in a slot for a sidelink communication; and means for, in accordance with a determination that the first frame structure is allowed to be used in the slot in coexistence with the second frame structure, determining at least a first set of resources reserved for a first transmission using the first frame structure and a second set of resources reserved for a second transmission using the second frame structure based on at least one sidelink control channel.

In a seventh aspect, there is provided a computer readable medium having a computer program stored thereon which, when executed by at least one processor of a device, causes the device to carry out the method according to the third aspect or the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings.

FIG. 1 illustrates an example environment in which example embodiments of the present disclosure may be implemented;

FIG. 2 shows a signaling chart illustrating a process of the resource allocation for different frame structures in sidelink communication according to some example embodiments of the present disclosure;

FIG. 3 shows a diagram of full-slot and sub-slot structures according to some example embodiments of the present disclosure;

FIG. 4 shows a flowchart of an example method of the resource allocation for different frame structures in sidelink communication according to some example embodiments of the present disclosure;

FIG. 5 shows a flowchart of an example method of the resource allocation for different frame structures in sidelink communication according to some example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals may represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein may have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first,” “second” and the like may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements >” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other resource enabling a communication, and the like. In the following, unless explicitly stated, a resource in both frequency domain and time domain will be used as an example of a transmission resource for describing some example embodiments of the present disclosure. It is noted that example embodiments of the present disclosure are equally applicable to other resources in other domains.

### Example Environment

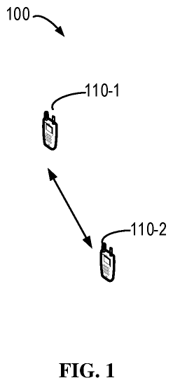

FIG. 1 shows an example communication network 100 in which embodiments of the present disclosure may be implemented. As shown in FIG. 1, the communication network 100 may comprise a terminal device 110-1 (hereinafter may also be referred to as a Transmit (Tx) UE 110-1 or a first device 110-1) and a terminal device 110-2 (hereinafter may also be referred to as a Receive (Rx) UE 110-2 or a second device 110-2). The terminal devices 110-1 and 110-2 may communicate with each other.

It is to be understood that the terminal device 110-1 may work as a Rx UE and the terminal device 110-2 may work as a Tx UE in some other scenarios.

In some scenarios, the communication between the UEs 110-1 and 110-2 in the communication network 100 may referred to as a sidelink communication. In the sidelink communication, the communication between terminal devices (for example, V2V, V2P, V2I communications) can be performed via sidelinks. For the sidelink communication, information may be transmitted from a TX terminal device to one or more RX terminal devices in a broadcast, or groupcast, or unicast manner.

It is to be understood that the number of terminal devices shown in FIG. 1 is given for the purpose of illustration without suggesting any limitations. The communication network 100 may include any suitable number of terminal devices.

Furthermore, the communication network 100 may also comprise a network device 120 (hereinafter may also be referred to as a gNB 120). The network device 120 may communicate with the UEs 110-1 and 110-2.

In some scenarios, the network device 120 may be responsible for the resource allocation of the sidelink transmission, which may be called as the resource allocation mode 1. For example, the gNB 120 may provide grants of sidelink resources to the UE 110-1 for the sidelink communication between the UEs 110-1 and 110-2 in the resource allocation mode 1.

In some other scenarios, a Tx UE may autonomously select transmission resources for the sidelink communication, which may be called as the resource allocation mode 2. For example, if the UE 110-1 autonomously select transmission resources for the sidelink communication between the UEs 110-1 and 110-2, the UE 110-1 may perform a sensing procedure over the configured sidelink transmission resource pool(s), to obtain the knowledge of the reserved resource(s) by other nearby sidelink Tx UE(s). Based on the knowledge obtained from resource sensing, the UE 110-1 may select resource(s) from the available sidelink resources, accordingly.

The sidelink control information (SCI) may be decoded for the UE 110-1 to perform sensing and obtain the necessary information associated with the sidelink transmission. The SCI associated with data transmission may include a 1^{st}-stage SCI and a 2^{nd}-stage SCI. For example, the 1^{st}-stage SCI may be carried by Physical Sidelink Control Channel (PSCCH) and comprise information to enable sensing operations and information needed to determine resource allocation of the Physical Sidelink Shared Channel (PSSCH) and to decode 2^{nd}-stage SCI.

The 2^{nd}-stage SCI may be carried by PSSCH, which may be multiplexed with sidelink shared channel (SL-SCH) and comprise source and destination identities for the sidelink transmission, information to identify and decode the associated SL-SCH Transport Block (TB), control of Hybrid Automatic Repeat Request (HARQ) feedback in unicast/groupcast, and a trigger for Channel State Information (CSI) feedback in unicast.

In sub-7 GHz unlicensed bands, the NR coexistence with other systems (e.g., IEEE 802.11) may be ensured via a Listen Before Talking (LBT) channel access mechanism. That is, the UE intending to perform a sidelink transmission may need to successfully complete an LBT check before being able to initiate the transmission.

For a UE to pass an LBT check, it must observe the channel as available for several consecutive Clear Channel Assessment (CCA) slots. In sub-7 GHz, the duration of these slots is 9 μs. The UE may consider the channel as available in a CCA slot if the measured power (i.e., the collected energy during the CCA slot) is below a specified threshold (which can depend on the operating band and geographical region).

When a UE initiates the communication (i.e., the UE takes the role of initiating device, for example, the UE 110-1 as shown in FIG. 1), the UE may have to acquire the “right” to access the channel for a certain period of time, which may be called as the Channel Occupancy Time (COT), by applying an “extended” LBT procedure where the channel must be deemed as free for the entire duration of a Contention Window (CW). This “extended” LBT procedure may be referred to as LBT Type 1.

The duration of both the COT and CW depends on the Channel Access Priority Class (CAPC) associated with the UE's traffic, which is shown as below.

TABLE 1
Channel Access Priority Class (CAPC) for UL

| Channel | | | | | |
|---|---|---|---|---|---|
| Access | | | | | |
| Priority | | | | | |
| Class (p) | mₚ | CW_{min, p} | CW_{max, p} | T_{ulmcot, p} | allowed CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or | {15, 31, 63, 127, |
| | | | | 10 ms | 255, 511, 1023} |
| 4 | 7 | 15 | 1023 | 6 ms or | {15, 31, 63, 127, |
| | | | | 10 ms | 255, 511, 1023} |

NOTE1:
For p = 3, 4, T_{ulmcot, p} = 10 ms if the higher layer parameter absenceOfAnyOtherTechnology-r14 or absenceOfAnyOtherTechnology-r16 is provided, otherwise, T_{ulmcot, p} = 6 ms.
NOTE 2:
When T_{ulmcot, p} = 6 ms it may be increased to 8 ms by inserting one or more gaps. The minimum duration of a gap shall be 100 us. The maximum duration before including any such gap shall be 6 ms.

In the Table 1, The contention window length in CCA slots associated with each CAPC has a minimum (CW_{min,p}) and maximum (CW_{max,p}). The duration of the COT is given by T_{ulm cot,p}. The control plane traffic (such as PSCCH) is transmitted with p=1, while user plane traffic has p>1. In Table 1, the LBT Type 1 details is depicted for the Uu uplink (UL) case, the downlink (DL) case LBT Type 1 parameters may also be adopted in the sidelink communication.

The UE initiating the transmission upon successfully completing the LBT Type 1 and performing a transmission, may acquire the COT with duration associated with the corresponding CAPC. The acquired COT is valid even in the case where the initiating device pauses its transmission. If the initiating device intends to perform a new transmission (within the COT), it is still required to perform a “reduced” LBT procedure. This “reduced” LBT procedure, may be referred to as LBT Type 2.

The LBT Type 2 may refer to different variants, namely Type 1 LBT, Type 2A/2B LBT and Type 2C LBT. The LBT Type 2A and the LBT Type 2B, which may also be referred to as LBT Category 2 (LBT Cat.2), may be used in different cases. For example, the Type 2A LBT may be used for the sidelink transmissions within the initiating device acquired COT, in case the gap between two sidelink transmissions is ≥25 μs, as well for the sidelink transmissions following another sidelink transmission. The LBT Type 2B may be used for the sidelink transmission within the initiating device acquired COT in case sidelink transmissions following another sidelink transmission with gap exactly equal to 16 μs.

Furthermore, the LBT Type 2C, which may also be referred to as LBT Category 1 (LBT Cat.1), may only be used for sidelink transmission following another sidelink, with a gap <16 μs and the allowed duration of the sidelink transmission ≤584 μs.

The initiating device may share the acquired COT with its intended receiver (the responding device or the Rx UE). For this purpose, the initiating device may inform (e.g., via a control signaling) the responding device about the duration of this COT. The responding device may use this information to decide which type of LBT is to be applied upon performing a transmission towards the initiating device. In a case where the responding device transmission falls outside the COT, the responding device may have to acquire a new COT using the LBT Type 1 with the appropriate CAPC.

The configuration of the resources in the sidelink resource pool may define the minimum information required for a Rx UE to be able to decode a transmission, which may comprise, for example, the number of sub-channels, the number of PRBs per sub-channels, the number of symbols in the PSCCH.

However, the details of the actual sidelink transmission (i.e., the payload) may be provided in the PSCCH (1^{st}-stage SCI) for each individual transmission, which may comprise, for example, the time and frequency resources, the Demodulation Reference Signal (DMRS) configuration of the PSSCH, the Modulation and Coding Scheme (MCS), Physical Sidelink Feedback Channel (PSFCH), among others.

The configuration of the PSCCH (e.g., DMRS, MCS, number of symbols used) is part of the resource pool configuration. Furthermore, the indication of which slots have PSFCH symbols is also part of the resource pool configuration. However, the configuration of the PSSCH (e.g., the number of symbols used, the DMRS pattern and the MCS) is provided by the 1^{st}-stage SCI which is the payload sent within the PSCCH.

In NR sidelink, a Bandwidth Part (BWP) level configuration may define the starting symbol and length of symbol for all of the sidelink slots in the BWP. In other words, a certain sidelink starting symbol is indicated by higher layer parameter “SL-starting symbol” and thus only one start position is configured in a slot in the resource pools belonging to the BWP.

However, in unlicensed band, the sidelink UE may face LBT failure issue for the solo one starting symbol position and cannot perform transmission until next starting symbol in a future slot with available candidate resource, which causes transmission delay and may also have the risk of losing the channel. Hence, it is to be expected that multiple sidelink starting points may be introduce for one transmission slot in sidelink unlicensed spectrum (SL-U) to make the UE have more channel access opportunities. For this topic, whether/how to support one additional starting point within a slot for a sidelink transmission such as PSCCH/PSSCH, which means at least two starting points within a transmission slot may be supported for sidelink transmission in unlicensed band, may need to be further discussed.

For example, if two starting points may be configured correspond to the starting point of a full-slot frame structure and the starting point of a sub-slot frame structure within one transmission slot, the Tx UE may perform PSCCH/PSSCH transmission based on the full-slot frame structure. Even if LBT fails before the first starting point, the Tx UE may have an additional LBT opportunity within the slot before the second starting point. If the LBT succeeds before the second starting point, the UE may perform PSCCH/PSSCH transmission based on the sub-slot frame structure. With the “full-slot frame structure”, the transmission may be performed in an entire slot, which may occupy 14 symbols, while with the “sub-slot frame structure”, the transmission may be performed in a portion of a slot. It is to be understood that the full-slot frame structure may be used in coexistence with a plurality of sub-slot frame structures, which means at least two starting points may be configured for the full-slot frame structure and the corresponding sub-slot frame structures.

For supporting the full-slot frame structure and the sub-slot structure, the Tx UE may need prepare at least two OFDM waveforms with different starting points (i.e., the number of waveforms to be prepared matched the number of starting points). Furthermore, a TB to be transmitted in PSSCH may have to be prepared prior to the transmission. The time between the TB preparation and TB transmission is not marginal.

Since the actual length of the transmission is not known at the moment of the TB preparation, either the Tx UE may need to prepare two different TBs for the transmission slot regarding each starting point, which results in significant overhead, or may need to adjust the modulation and coding rate of the transmission, which may cause decoding performance degradation.

Moreover, one Tx UE may be a hidden node to another Tx UE with ongoing full-slot transmission. That is, the Tx UE which intends to start a sub-slot transmission may not hear the ongoing full-slot transmission through LBT. If the Rx UE which is trying to receive the full-slot transmission is nearby the sub-slot Tx UE, the sub-slot transmission may cause interference to the full-slot transmission, and thus result in the problem of Automatic Gain Control (AGC).

Therefore, how to reduce the complexity and cost for the SL-U with coexistent full-slot and sub-slot frame structures in a slot is to be further discussed.

### Work Principle and Example Signaling for Communication

According to some example embodiments of the present disclosure, there is provided a solution for the resource allocation for different frame structures in the sidelink communication. In this solution, if the first frame structure, for example, the sub-slot frame structure, is allowed to be used in coexistence with a second frame structure, for example, the full-slot frame structure, in a slot for a sidelink communication, the Tx UE reserves a first set of resources for a first transmission using the first frame structure. The first set of resources are associated with the second set of resources reserved for the second transmission using second frame structure and the Tx UE indicates the first and the second sets of the resources via at least one sidelink control channel. Based on the solution of the present disclosure, an efficient resource allocation solution for better support of coexistent full-slot and sub-slot frame structures for SL-U is achieved.

Example embodiments of the present disclosure will be described in detail below with reference to the accompanying drawings.

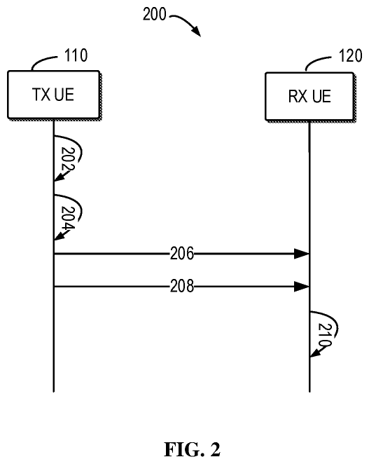

Reference is now made to FIG. 2, which shows a signaling chart 200 for communication according to some example embodiments of the present disclosure. As shown in FIG. 2, the signaling chart 200 involves a Tx UE 110-1 and a Rx UE 110-2. For the purpose of discussion, reference is made to FIG. 1 to describe the signaling chart 200. Although two UEs are illustrated in FIG. 2, it would be appreciated that there may be a plurality of UEs performing similar operations as described with respect to the Tx UE 110-1 or the Rx UE 110-2 below.

In some embodiments, if the Tx UE 110-1 initiates a sidelink transmission, the Tx UE 110-1 may search candidate resources potentially available for a full-slot transmission by monitoring the first stage SCIs of other Tx UEs in at least one of the full-slot PSCCH, or the sub-slot PSCCH based on the network configuration, and then reserve resources from the candidate resources to launch the full-slot transmission (e.g., AGC/PSCCH/PSSCH). Hereinafter the resources reserved by the Tx UE 110-1 for the full-slot transmission may be referred to as a second set of resources.

The Tx UE 110-1 may determine whether a sub-slot frame structure is allowed to be used in coexistence with a full-slot structure in a same slot for the sidelink communication. One condition for the Tx UE 110-1 to determine whether resources could be reserved for a sub-slot transmission in a (future) slot is that the resources for a full-slot transmission in this same slot are reserved. That is, only if it reserved resources for full-slot transmission in the same slot, the Tx UE 110 can further reserve resources for the sub-slot transmission in this slot. Hereinafter the resources reserved by the Tx UE 110-1 for the sub-slot transmission may be referred to as a first set of resources.

If the sub-slot frame structure is allowed to be used in coexistence with the full-slot structure in a same slot for the sidelink communication, as shown in FIG. 2, the Tx UE 110-1 may determine 202 the first set of resources reserved for the sub-slot transmission. The resource allocation for the first set of resources used for the sub-slot transmission may refer to the time domain range and the frequency domain range.

For the time domain resource allocation, the first set of resources reserved for the sub-slot transmission may be reserved in a same slot within which the second set of resources are reserved for the full-slot transmission. In this slot, the sub-slot transmission and the full-slot transmission may be configured with different starting points. For example, the time domain resource allocation for sub-slot transmission (i.e., which slots) can be implicitly determined by full-slot transmission if the sub-slot transmission is to be performed.

For the frequency domain resource allocation, the Tx UE 110 may reserve frequency domain resources (i.e., which sub-channels) for sub-slot transmission either the same as that for the full-slot transmission or separate from that for the full-slot transmission. If the sub-slot transmission is configured with different frequency domain resource allocation from that of the full-slot transmission, the Tx UE 110-1 may need to find out candidate resources potentially available for the sub-slot transmission in the (future) slot by monitoring the SCIs of other Tx UEs in the full-slot PSCCH or in the sub-slot PSCCH, and then selects/reserves the frequency resource from the candidate resources to launch the sub-slot transmission (e.g., AGC/PSCCH/PSSCH).

For example, the size of the frequency range of the first set of resources reserved for the sub-slot transmission may be determined based on the size of the frequency range of the second set of the resources reserved for the full-slot transmission and respective starting point of the full-slot transmission and the sub-slot transmission. That is, the frequency resource size (i.e., the number of sub-channels) for the sub-slot transmission may achieve similar decoding performance as the full-slot transmission, e.g., the transmitter may reserve twice as many frequency resources for sub-slot transmission as for the full-slot transmission.

It is to be understood that the frequency resource allocation approach may also be pre-configured or configured to SL UE by the network, i.e., a gNB.

As described above, by introducing the additional starting point in a same slot, the resource allocation for both full-slot transmission and sub-slot transmission may increase channel access opportunity for the SL-U, while being implemented with low complexity after considering certain constraint during the resource allocation for the sub-slot transmission.

Furthermore, the Tx UE 110-1 may prepare 204 a TB for the full-slot transmission and/or the sub-slot transmission.

The Transport Block Size (TBS) may be determined for the full-slot transmission and the sub-slot transmission. A same TBS may be used for both the full-slot and the sub-slot transmissions and may further be dynamically determined based on either resource allocation of the full-slot transmission or the resource allocation of the sub-slot transmission.

The Tx UE 110 may determine the TBS based on at least one of the metrics such as the traffic size arrived at the buffer, e.g., large or small traffic size the amount of traffic; the traffic type arrived at the buffer (e.g., enhanced Mobile Broadband (eMBB), Ultra Reliable Low Latency Communications (URLLC) or Internet of Things (IoT)); the Channel Busy Ratio (CBR) of inter-RAT or/and intra-RAT or Channel Occupancy Ratio (CR) measured level; or the sensing results, e.g., the resource reservation status or interference level.

For example, the determination may be made based on resource allocation of full-slot transmission in the case of large traffic size, eMBB traffic, low CBR, or/and low interference over the reserved resource. Alternatively, the determination may be made based on the resource allocation of sub-slot transmission in the case of small traffic size, URLLC traffic, or/and high interference over the reserved resource.

As another option, the TBS may be implicitly determined based on resource allocation of the sub-slot transmission as default if the sub-slot frame structure is used/indicated by the Tx UE 110-1.

Furthermore, the TBS may also be pre-defined/configured based on the resource allocation of either full-slot transmission or sub-slot transmission.

The Tx UE 110-1 may prepare TBs for the full-slot transmission and/or the sub-slot transmission.

In a case where the TBS is determined by the sub-slot frame structure, as an option, one TB may be prepared for the sub-slot transmission, and then two copies of the TB may be used for full-slot transmission. That is, one copy of the TB is used for the first half of the slot and another copy of the TB is used for the second half of the slot. As another option, the Tx UE 110-1 may prepare one TB for the sub-slot transmission and adapt the modulation order of the sub-slot TB to next lower value for full-slot transmission.

In a case where the TBS is determined by the full-slot frame structure, as an option, the Tx UE 110-1 may prepare one TB for the full-slot transmission, and then adapt the modulation order of the full-slot TB to next higher value for sub-slot transmission. It is also possible that the Tx UE 110-1 may prepare one single TB for both the full-slot transmission and sub-slot transmission. If the Tx UE 110-1 fails to access the channel at the first starting point, it can try to perform sub-slot transmission from the second starting point if LBT successes by puncturing the first part of the slot or puncturing the slot.

It is to be understood that the TBS determined based on either the resource allocation of the full-slot transmission or the resource allocation of the sub-slot transmission may be pre-defined/configured for both Tx UE or Rx UE, or dynamically signalled to the Rx UE through the 1^{st}-stage SCI or the 2^{nd} stage SCI of the full-slot PSCCH or the sub-slot PSCCH in a slot by the Tx UE.

The predefined/configured TBS for both the full-slot and sub-slot transmissions may facilitate the TB preparation for coexistence of the full-slot and sub-slot frame structures with low implementation complexity (e.g., modulation order adjustment, TB repetition or data puncture) to meet the time budget requirement. Moreover, the dynamic TBS determination may well meet the scheduling/traffic requirement taking actual channel status into account.

Furthermore, as shown, the Tx UE 110 may indicate 206, for example, to the Rx UE 110-2, the allocated resources for the full-slot transmission and the sub-slot transmission via a control channel, i.e., a PSCCH.

In some embodiments, when indicating the resource allocation via a PSCCH, the 1^{st}-stage SCI carried by the PSCCH may contain the information to determine resource allocation of PSSCH, i.e., determine which slots and which sub-channels are selected/allocated for PSSCH transmissions, where the time resource allocation (i.e. which slots) are determined based the time resource assignment and the resource reservation period in the 1^{st} stage SCI carried in the PSCCH, and the frequency time resource allocation (i.e. which sub-channels) are determined based on the frequency resource assignment in the 1^{st} stage SCI carried in the PSCCH.

Different PSCCHs may be configured for the full-slot transmission and the sub-slot transmission, respectively. For example, a full-slot PSCCH and a sub-slot PSCCH may be associated with the full-slot transmission and the sub-slot transmission, respectively.

It is to be understood that the occasion for the Tx UE 110-1 to indicate the resource allocation, for example, to the Rx UE 110-2, may be in a previous slot prior to the slot within which the full-slot transmission or the sub-slot transmission to be performed. It is also possible that the Tx UE 110-1 indicates the resource allocation in the slot within which the full-slot transmission or the sub-slot transmission is performed.

In some embodiments, the indication of both the first and the second sets of resources may be transmitted, for example, to the Rx UE 110-2, in a previous slot prior to the slot within which the full-slot transmission or the sub-slot transmission to be performed.

As an option, the resource allocation of both the full-slot transmission and the sub-slot transmission (i.e., the first set of resources and the second set of resources) may be indicated only via a full-slot PSCCH. As another option, the resource allocation of both the full-slot transmission and the sub-slot transmission may also be indicated via a sub-slot PSCCH. In a further option, the resource allocation of the sub-slot transmission may also be indicated via a sub-slot PSCCH.

In this case, the time/frequency resource allocation of both PSCCH and PSSCH for the sub-slot transmission may be indicated in full-slot PSCCHs. That is, a SL-U UE only needs to monitor full-slot PSCCHs to determine resource assignment for both the full-slot and sub-slot transmissions, which may not increase additional PSCCH blind detection complexity after introducing the additional starting point of the sub-slot transmission.

In some other embodiments, it is also possible that the resource allocation of the full-slot transmission or the sub-slot transmission may be indicated in the slot, within which the full-slot transmission or the sub-slot transmission is performed, via either the full-slot PSCCH or the sub-slot PSCCH depending on the LBT outcome.

For example, before the starting point of the full-slot transmission in a slot, the Tx UE 110 may perform a LBT procedure. If the LBT is successful, the Tx UE 110 may perform a full-slot transmission and indicate the resource allocation, i.e., for the full-slot transmission via the full-slot PSCCH. If the LBT is unsuccessful, the Tx UE 110 may perform a further LBT procedure before the starting point of the sub-slot transmission in this slot. If the LBT is successful, the Tx UE 110 may perform a sub-slot transmission and indicate the resource allocation, i.e., for the sub-slot transmission via the sub-slot PSCCH.

In this case, the PSCCH blind detection complexity may be increased but more resource allocation opportunity for full-slot transmission and sub-slot transmission may be obtained.

Regarding to the indication of time resource allocation, one-bit information may be used to indicate usage and resource allocation of sub-slot transmission. For example, if the bit information is set to 0, the sub-slot transmission is not used in all the slots indicated by the time resource allocation in the full-slot PSCCH. Otherwise, the sub-slot transmission is to be used and has the same time resource allocation as full-slot transmission but different starting point from full-slot transmission.

Furthermore, the resource allocation indication for the full-slot transmission may be configured in the full-slot PSCCH, which may allocate resources involved in multiple slots. A bitmap carried in the full-slot PSCCH may be used to indicate time resource allocation for sub-slot transmission, e.g., which of the multiple slots used for the full-slot transmission can be used/allocated for sub-slot transmission.

Regarding to the indication of frequency resource allocation, assuming that sub-slot transmission is pre-defined/pre-configured to use the same frequency resource allocation as full-slot transmission, which means the frequency resource allocation of sub-slot transmission may be determined based on the frequency resource allocation of full-slot transmission. In this case, it is unnecessary to additionally indicate the frequency resource allocation for sub-slot transmission. Alternatively, assuming that sub-slot transmission is allowed to have the different frequency resource allocation from full-slot transmission based on pre-definition or pre-configuration, it is necessary to additionally indicate the frequency resource allocation for sub-slot transmission for these slots which are scheduled for sub-slot transmission.

Besides the resource allocation information for a full-slot transmission, some other information may also be included in the control information to indicate the resource allocation for a sub-slot transmission. For example, an indication of sub-slot transmission usage may be included, which may indicate which of the slots indicated by resource assignment for full-slot transmission is/are to be used/allocated for the sub-slot transmission. Furthermore, the frequency resource assignment of the sub-slot transmission may be included. This information may be omitted if the sub-slot transmission has the same frequency range of the resource allocation as the full-slot transmission.

In some embodiment, in a case where the PSCCH occasion is determined based on the resource allocation for sub-slot transmission, the 1^{st}-stage SCI included in the sub-slot PSCCH may mainly contain information to determine resource allocation and decoding information of the 2^{nd}-stage SCI (e.g., DMRS pattern, 2^{nd}-stage SCI format, Beta_offset indicator, Number of DMRS port, additional MCS table indicator, etc). Alternatively or optionally, the 1^{st}-stage SCI may contain or not contain resource allocation information for full-slot/sub-slot based on the different PSCCH design. The 2^{nd}-stage SCI may mainly contain information such as source and destination identities, information to identify and decode the associated SL-SCH TB, control of HARQ feedback in unicast/groupcast, trigger for CSI feedback in unicast. Furthermore, the TBS determination based on full-slot or sub-slot can also be placed in the 2^{nd}-stage SCI.

The Tx UE 110-1 may transmit 208 the TB via a PSSCH if a full-slot transmission or a sub-slot transmission is performed. It is to be understood that the transmission of the TB may also be performed in a same slot with which the resource allocation and other corresponding information are indicated to the Rx UE 110-2, which is shown in action 206 in FIG. 2.

For example, when the Tx UE 110-1 initiates a TB transmission, the Tx UE 110-1 may, for example, the Tx UE 110 may perform a LBT procedure before the starting point of the full-slot transmission in a slot. If the LBT is successful, the Tx UE 110 may transmit the TB via a full-slot transmission. If the LBT is unsuccessful, the Tx UE 110 may perform a further LBT procedure before the starting point of the sub-slot transmission in this slot. If the LBT is successful, the Tx UE 110 may transmit the TB via the sub-slot transmission.

In some embodiments, the Tx UE 110 110-1 may perform a sidelink transmission (e.g., AGC/PSCCH/PSSCH) using the sub-slot frame structure, i.e., the sub-slot transmission, if at least one of the following conditions is met. For example, the sub-slot transmission may be performed if resource is reserved/allocated for sub-slot transmission toward the Rx UE 110-2 in current slot where the resource reservation/allocation has been indicated to the Rx UE 110-2 in previous slot(s). The sub-slot transmission may also be performed if the LBT fails for full-slot transmission in current slot and/or LBT succeeds for sub-slot transmission in current slot. Optionally, the sub-slot transmission may be performed if non-ongoing transmission is detected in current slot for full-slot from other Tx UEs over the reserved resources for sub-slot towards the Rx UE 110-2, where the detection may be done by monitoring the (full-slot) PSCCH of other Tx UEs.

If a full-slot transmission is performed, an AGC symbol may be transmitted at the starting point of full-slot frame structure, for the Rx UE to perform the AGC. If sub-slot frame structure is allowed for sidelink transmission, the Tx UE 110-1 may also transmit an AGC symbol at the starting point of the sub-slot transmission (i.e., at the starting point of the sub-slot) for full-slot transmission.

In some embodiments, for a sub-slot transmission, an AGC symbol may be transmitted by the Tx UE at the starting point of the sub-slot frame structure.

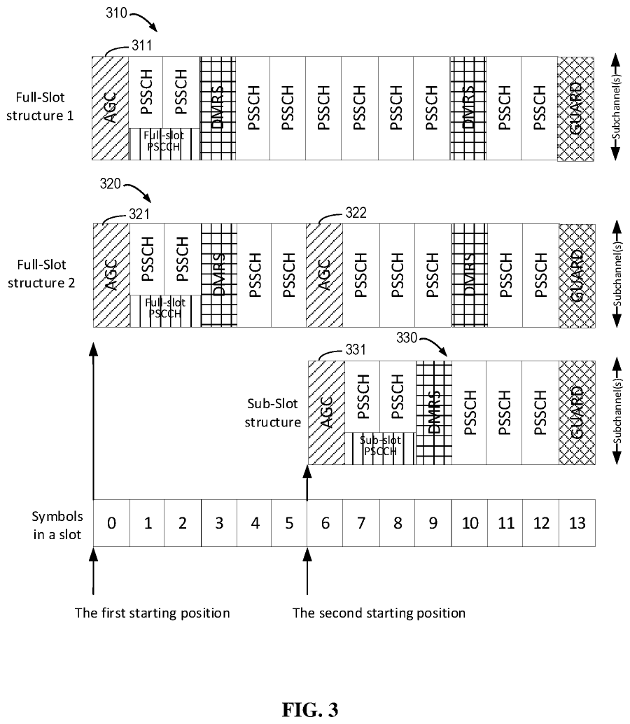

FIG. 3 shows a diagram for the full-slot and sub-slot structure according to the embodiments of the present disclosure. As shown, the full-slot frame structure 310 and 320 may start at 0^{th} symbol in a slot. The full-slot frame structure 310 and 320 may comprise symbols AGC (for example 311 and 321), PSCCH, PSSCH, DMRS, etc. Difference between the full-slot frame structure 310 and 320 is that: an additional AGC symbol 322 is configured in the full-slot frame structure at the 6^{th} symbol in the slot, which may be the starting point of the sub-slot frame structure. Similarly, there is an AGC symbol 331 at the starting point (at 6^{th} symbol in the slot) of the sub-slot frame structure 330.

As shown in FIG. 3, the full-slot frame structure and the sub-slot frame structure may be supported in a same slot, which has been described as above. For the frequency domain, the full-slot frame structure and the sub-slot frame structure may be configured with same frequency ranges or different frequency ranges. For example, one sub-channel may be allocated for full-slot transmission whilst two sub-channels may be allocated for sub-slot transmission in the same slot to ensure the similar decoding performance of TB with full-slot transmission.

Now the reference is back to FIG. 2, as acting as a receiver in the sidelink transmission, the Rx UE 110-2 may perform 210 a PSCCH blind detection based on the configured occasions associated with the PSCCH and determine whether a sub-slot transmission is performed.

For example, if the Rx UE 110-2 detects the usage indication of the sub-slot transmission, the Rx UE 110-2 may determine the sub-slot transmission is used for at least one slot. The Rx UE 110-2 may further determine the frequency resource allocation for sub-slot transmission through a full-slot PSCCH or a sub-slot PSCCH.

For example, the Rx UE 110-2 may perform sub-slot PSCCH blind detection if resource is reserved/allocated for the Rx UE 110-2 for sub-slot transmission in current slot where the resource reservation/allocation has been indicated to the Rx UE 110-2 in previous slot(s) prior to the current slot associated with the sub-slot transmission.

It is also possible that the Rx UE 110-2 may obtain the indication of resource allocation for sub-slot transmission in a same slot with the sub-slot transmission. For example, if the non-ongoing full-slot transmission is detected in this slot from the Tx UE 110-1, the Rx UE 110-1 may perform sub-slot PSCCH blind detection.

Based on the solution of the present disclosure, channel access opportunity for sidelink transmission in unlicensed band may be increased by introducing an additional starting point in a slot, whilst being implemented with low complexity after considering certain constraint during the resource allocation for sub-slot.

Furthermore, PSCCH blind detection complexity can be reduced by indicating the resource allocation of sub-slot transmission through the full-slot PSCCHs and resource allocation opportunity for full-slot and sub-slot may be increased due to joint resource allocation indication of full-slot and sub-slot through either the full-slot PSCCH or the sub-slot PSCCH.

Moreover, the TB preparation complexity is reduced by considering the same TBS design for full-slot and sub-slot transmission, and meanwhile the scheduling/traffic requirement may be met better by using dynamic TBS determination approach.

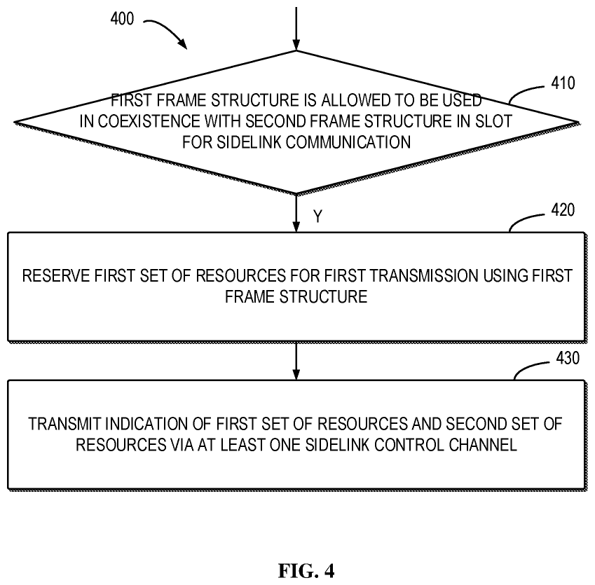

FIG. 4 shows a flowchart of an example method 400 of the resource allocation for different frame structures in sidelink communication according to some example embodiments of the present disclosure. The method 400 may be implemented at the first device 110-1 as shown in FIG. 1. For the purpose of discussion, the method 400 will be described with reference to FIG. 1.

At 410, if the first device determines that a first frame structure is allowed to be used in coexistence with a second frame structure in a slot for a sidelink communication, at 420, the first device reserves a first set of resources for a first transmission using the first frame structure. The first set of resources are associated with a second set of resources reserved for a second transmission using the second frame structure.

In some example embodiments, the first frame structure is a sub-slot frame structure and the second frame structure is a full-slot frame structure.

In some example embodiments, the first device may reserve the first set of resources for the first transmission if the second set of resources has been reserved for the second transmission in a same slot.

In some example embodiments, the first set of resources are reserved on a same or different frequency range with the second set of resources.

In some example embodiments, the first set of resources and second set of resources are reserved in the same slot with different starting points.

In some example embodiments, a first size of a first frequency range, on which the first set of resources are reserved, is associated with a second size of a second frequency range on which the second set of resources are reserved and at least one of the starting point of the first transmission, or the starting point of the second transmission, if the first and the second set of resources are reserved on different frequency ranges.

At 430, the first device transmits an indication of the first set of resources and the second set of resources via at least one sidelink control channel.

In some example embodiments, the first device may indicate both the first set of resources and the second set of resources in a previous slot prior to the slot via at least one of a first sidelink control channel for the first frame structure or a second sidelink control channel for the second frame structure.

In some example embodiments, the first device may indicate the first set of resources in the slot via a first sidelink control channel for the first frame structure.

In some example embodiments, the first device may further indicate at least one of the first frame structure is used, a portion of a slot for the second transmission is used to the first transmission, or a frequency range associated with the first set of resources reserved for the first transmission if the first set of resources are reserved on a different frequency range with the second set of resources.

In some example embodiments, the first device may indicate a usage of the first frame structure and the first set of resources reserved for the first transmission via one-bit information.

In some example embodiments, the first device may indicate a time domain assignment for the first set of resources by using a bitmap associated with the second set of resources.

In some example embodiments, the indication of the first and the second sets of resources is included or excluded in a first stage sidelink control information.

In some example embodiments, a transport block size is determined based on the first frame structure or the second frame structure.

In some example embodiments, a same transport block size is configured for both the first and the second transmissions.

In some example embodiments, a transport block size is determined based on at least one of a traffic size arrived at a buffer of the first device, a traffic type arrived at the buffer, a channel busy ratio, or results of a sensing process.

In some example embodiments, the determination of the transport block size is indicated in a first stage sidelink control information or a second stage sidelink control information.

In some example embodiments, the first device may further transmit an AGC symbol at at least one of the starting point of the second transmission, or the starting point of the first transmission.

In some example embodiments, the first transmission is allowed to be performed in the sidelink communication if at least one of condition is satisfied. The at least one of condition comprises at least one of the first set of resources reserved for the first transmission has been indicated to a second device in a previous slot prior to the slot associated with the first transmission, a listen before talk process for the second transmission fails, a listen before talk process for the first transmission is successful, or no transmission using the second frame structure is detected in the slot at the first device.

In some example embodiments, the first device comprises a transmitter in the sidelink communication, and wherein the second device comprises a receiver in the sidelink communication.

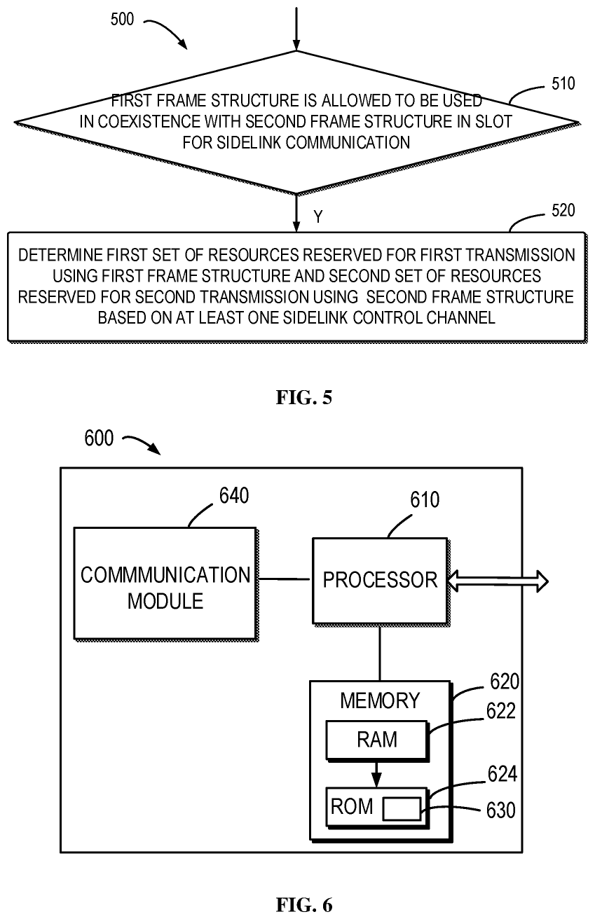

FIG. 5 shows a flowchart of an example method 500 of the resource allocation for different frame structures in sidelink communication according to some example embodiments of the present disclosure. The method 500 may be implemented at the second device 110-2 as shown in FIG. 1. For the purpose of discussion, the method 500 will be described with reference to FIG. 1.

At 510, if the second device determines a first frame structure is allowed to be used in coexistence with a second frame structure in a slot for a sidelink communication, at 520, the second device determines at least a first set of resources reserved for a first transmission using the first frame structure and a second set of resources reserved for a second transmission using the second frame structure based on at least one sidelink control channel.

In some example embodiments, the first frame structure is a sub-slot frame structure and the second frame structure is a full-slot frame structure.

In some example embodiments, the second device may determine that the first frame structure is allowed to be used in the slot in coexistence with the second frame structure based on an indication of a usage of the first frame structure.

In some example embodiments, the second device may receive an indication of both the first set of resources and the second set of resources in a previous slot prior to the slot via: at least one of a second sidelink control channel for the second frame structure or a first sidelink control channel for the first frame structure.

In some example embodiments, the second device may receive an indication of the first set of resources in the slot via a first sidelink control channel for the first frame structure.

In some example embodiments, the second device may determine that the first set of resources are reserved on a same or different frequency range with the second set of resources.

In some example embodiments, the second device may determine that the first set of resources are reserved on a same or different frequency range with the second set of resources.

In some example embodiments, the second device may determine that the first set of resources and second set of resources are reserved on a same slot with different starting points.

In some example embodiments, a first size of a first frequency range, on which the first set of resources are reserved, is associated with a second size of a second frequency range on which the second set of resources are reserved and at least one of the starting point of the first transmission, or the starting point of the second transmission, if the first and the second set of resources are reserved on different frequency ranges.

In some example embodiments, the second device may receive an indication of a usage of the first frame structure and the first set of resources reserved for the first transmission via one-bit information.

In some example embodiments, the second device may receive an indication of a time domain assignment for the first set of resources by a bitmap associated with the second set of resource.

In some example embodiments, an indication of the first and the second sets of resources is included or excluded in a first stage sidelink control information.

In some example embodiments, the second device may receive the first transmission on the first set of resources or the second transmission on the second set of resources.

In some example embodiments, a transport block size is determined based on the first frame structure or the second frame structure.

In some example embodiments, a same transport block size is configured for both the first and the second transmissions.

In some example embodiments, the transport block size is indicated in a first stage sidelink control information or a second stage sidelink control information.

In some example embodiments, the second device may detect an AGC symbol for the second transmission at at least one of the starting point of the second transmission, or the starting point of the first transmission.

In some example embodiments, the second device may perform a detection on a first control channel for the first frame structure if at least one condition is satisfied, the at least one condition comprises at least one of the first set of resources reserved for the first transmission has been indicated to the second device in a previous slot prior to a slot a slot associated with the first transmission, and no transmission from a first device using the second frame structure is detected in the slot.

In some example embodiments, the first device comprises a transmitter in the sidelink communication, and wherein the second device comprises a receiver in the sidelink communication.

### Example Apparatus, Device, and Medium

In some example embodiments, an apparatus capable of performing the method 400 (for example, implemented at the first device 110-1) may include means for performing the respective steps of the method 400. The means may be implemented in any suitable form. For example, the means may be implemented in a circuitry or software module.

In some example embodiments, the apparatus comprises means for, in accordance with a determination that a first frame structure is allowed to be used in coexistence with a second frame structure in a slot for a sidelink communication, reserving a first set of resources for a first transmission using the first frame structure, the first set of resources being associated with a second set of resources reserved for a second transmission using the second frame structure; and means for transmitting an indication of the first set of resources and the second set of resources via at least one sidelink control channel.

In some example embodiments, the first frame structure is a sub-slot frame structure and the second frame structure is a full-slot frame structure.

In some example embodiments, the means for reserving the first set of resources may comprise means for reserving the first set of resources for the first transmission if the second set of resources has been reserved for the second transmission in a same slot.

In some example embodiments, the first set of resources are reserved on a same or different frequency range with the second set of resources.

In some example embodiments, the first set of resources and second set of resources are reserved in the same slot with different starting points.

In some example embodiments, a first size of a first frequency range, on which the first set of resources are reserved, is associated with a second size of a second frequency range on which the second set of resources are reserved and at least one of the starting point of the first transmission, or the starting point of the second transmission, if the first and the second set of resources are reserved on different frequency ranges.

In some example embodiments, the means for transmitting the indication of the first set of resources and the second set of resources may comprise means for transmitting an indication of the first set of resources and the second set of resources via at least one sidelink control channel.

In some example embodiments, the apparatus may further comprise means for indicating both the first set of resources and the second set of resources in a previous slot prior to the slot via at least one of a first sidelink control channel for the first frame structure or a second sidelink control channel for the second frame structure.

In some example embodiments, the apparatus may further comprise means for indicating the first set of resources in the slot via a first sidelink control channel for the first frame structure.

In some example embodiments, the apparatus may further comprise means for indicating at least one of the first frame structure is used, a portion of a slot for the second transmission is used to the first transmission, or a frequency range associated with the first set of resources reserved for the first transmission if the first set of resources are reserved on a different frequency range with the second set of resources.

In some example embodiments, the apparatus may further comprise means for indicating a usage of the first frame structure and the first set of resources reserved for the first transmission via one-bit information.

In some example embodiments, the apparatus may further comprise means for indicating a time domain assignment for the first set of resources by using a bitmap associated with the second set of resources.

In some example embodiments, the indication of the first and the second sets of resources is included or excluded in a first stage sidelink control information.

In some example embodiments, a transport block size is determined based on the first frame structure or the second frame structure.

In some example embodiments, a same transport block size is configured for both the first and the second transmissions.

In some example embodiments, a transport block size is determined based on at least one of a traffic size arrived at a buffer of the first device, a traffic type arrived at the buffer, a channel busy ratio, or results of a sensing process.

In some example embodiments, the determination of the transport block size is indicated in a first stage sidelink control information or a second stage sidelink control information.

In some example embodiments, the apparatus may further comprise means for transmitting an AGC symbol at at least one of the starting point of the second transmission, or the starting point of the first transmission.

In some example embodiments, the first transmission is allowed to be performed in the sidelink communication if at least one of condition is satisfied. The at least one of condition comprises at least one of the first set of resources reserved for the first transmission has been indicated to a second device in a previous slot prior to the slot associated with the first transmission, a listen before talk process for the second transmission fails, a listen before talk process for the first transmission is successful, or no transmission using the second frame structure is detected in the slot at the first device.

In some example embodiments, the first device comprises a transmitter in the sidelink communication, and wherein the second device comprises a receiver in the sidelink communication.

In some example embodiments, an apparatus capable of performing the method 500 (for example, implemented at the second device 110-2) may include means for performing the respective steps of the method 500. The means may be implemented in any suitable form. For example, the means may be implemented in a circuitry or software module.

In some example embodiments, the apparatus comprises means for determining whether a first frame structure is allowed to be used in coexistence with a second frame structure in a slot for a sidelink communication; and means for, in accordance with a determination that the first frame structure is allowed to be used in the slot in coexistence with the second frame structure, determining at least a first set of resources reserved for a first transmission using the first frame structure and a second set of resources reserved for a second transmission using the second frame structure based on at least one sidelink control channel.

In some example embodiments, the first frame structure is a sub-slot frame structure and the second frame structure is a full-slot frame structure.

In some example embodiments, the means for determining whether the first frame structure is allowed to be used may comprise means for determining that the first frame structure is allowed to be used in the slot in coexistence with the second frame structure based on an indication of a usage of the first frame structure.

In some example embodiments, the apparatus may further comprise means for receiving an indication of both the first set of resources and the second set of resources in a previous slot prior to the slot via: at least one of a second sidelink control channel for the second frame structure or a first sidelink control channel for the first frame structure.

In some example embodiments, the apparatus may further comprise means for receiving an indication of the first set of resources in the slot via a first sidelink control channel for the first frame structure.

In some example embodiments, the means for determining at least the first set of resources reserved for the first transmission may comprise means for determining that the first set of resources are reserved on a same or different frequency range with the second set of resources.

In some example embodiments, the means for determining at least the first set of resources reserved for the first transmission may comprise means for determining that the first set of resources are reserved on a same or different frequency range with the second set of resources.

In some example embodiments, the means for determining at least the first set of resources reserved for the first transmission may comprise means for determining that the first set of resources and second set of resources are reserved on a same slot with different starting points.

In some example embodiments, a first size of a first frequency range, on which the first set of resources are reserved, is associated with a second size of a second frequency range on which the second set of resources are reserved and at least one of the starting point of the first transmission, or the starting point of the second transmission, if the first and the second set of resources are reserved on different frequency ranges.

In some example embodiments, the apparatus may further comprise means for receiving an indication of a usage of the first frame structure and the first set of resources reserved for the first transmission via one-bit information.

In some example embodiments, the apparatus may further comprise means for receiving an indication of a time domain assignment for the first set of resources by a bitmap associated with the second set of resource.

In some example embodiments, an indication of the first and the second sets of resources is included or excluded in a first stage sidelink control information.

In some example embodiments, the apparatus may further comprise means for receiving the first transmission on the first set of resources or the second transmission on the second set of resources.

In some example embodiments, a transport block size is determined based on the first frame structure or the second frame structure.

In some example embodiments, a same transport block size is configured for both the first and the second transmissions.

In some example embodiments, the transport block size is indicated in a first stage sidelink control information or a second stage sidelink control information.

In some example embodiments, the apparatus may further comprise means for detecting an AGC symbol for the second transmission at at least one of the starting point of the second transmission, or the starting point of the first transmission.

In some example embodiments, the apparatus may further comprise means for performing a detection on a first control channel for the first frame structure if at least one condition is satisfied, the at least one condition comprises at least one of the first set of resources reserved for the first transmission has been indicated to the second device in a previous slot prior to a slot a slot associated with the first transmission, and no transmission from a first device using the second frame structure is detected in the slot.

In some example embodiments, the first device comprises a transmitter in the sidelink communication, and wherein the second device comprises a receiver in the sidelink communication.

FIG. 6 is a simplified block diagram of a device 600 that is suitable for implementing example embodiments of the present disclosure. The device 600 may be provided to implement a communication device, for example, the Tx UE 110-1 or the Rx UE 110-2 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

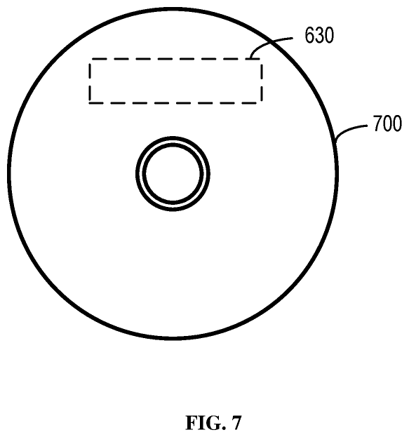

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-40. (canceled)

41. A first device comprising:
at least one processor; and
at least one memory storing instructions that, when executed by the at least one processor, cause the first device at least to:
determine a first set of resources reserved for a sub-slot transmission, wherein the first set of resources reserved for the sub-slot transmission is reserved in a same slot within which a second set of resources is reserved for a full-slot transmission;
prepare a transport block for the full-slot transmission and/or the sub-slot transmission;
perform a sidelink transmission using the sub-slot transmission when listening before talk fails for the full-slot transmission in the same slot.

42. The first device of claim 41, wherein the first device is caused to:
determine a transport block size for the transport block prepared for the full-slot transmission and the sub-slot transmission, wherein the full-slot transmission and the sub-slot transmission use the same transport block size.

43. The first device of claim 42, wherein the transport block size is determined based on a sub-slot frame structure or a full-slot frame structure.

44. The first device of claim 42, wherein a transport block size is determined based on at least one of the following:
a traffic size arrived at a buffer of the first device,
a traffic type arrived at the buffer,
a channel busy ratio, or
results of a sensing process.

45. The first device of claim 42, wherein the determination of the transport block size is indicated in a first stage sidelink control information or a second stage sidelink control information.

46. The first device of claim 41, wherein the first set of resources and second set of resources are reserved in the same slot with different starting points.

47. The first device of claim 46, wherein a first size of a first frequency range, on which the first set of resources is reserved, is associated with a second size of a second frequency range on which the second set of resources is reserved and with at least one of the following:
the starting point of the sub-slot transmission, or
the starting point of the full-slot transmission, if the first and the second sets of resources are reserved on different frequency ranges.

48. The first device of claim 46, wherein the first device is caused to:
transmit an automatic gain control symbol at at least one of the following:
the starting point of the full-slot transmission, or
the starting point of the sub-slot transmission.

49. The first device of claim 41, wherein the first device is caused to:
indicate both the first set of resources and the second set of resources in a previous slot prior to the slot via at least one of the following:
a first sidelink control channel for a sub-slot frame structure, or
a second sidelink control channel for a full-slot frame structure.

50. The first device of claim 41, wherein the first device is caused to:
indicate at least the first set of resources in the slot via a first sidelink control channel for a sub-slot frame structure.

51. The first device of claim 41, wherein the first device is further caused to:
indicate at least one of the following:
a sub-slot frame structure is used,
a portion of a slot for the full-slot transmission is used for the sub-slot transmission, or
a frequency range associated with the first set of resources reserved for the sub-slot transmission if the first set of resources are reserved on a different frequency range than the second set of resources.

52. The first device of claim 41, wherein the first device is further caused to:
indicate a usage of a sub-slot frame structure and the first set of resources reserved for the sub-slot transmission via one-bit information.

53. The first device of claim 41, wherein the first device is further caused to:
indicate a time domain assignment for the first set of resources by using a bitmap associated with the second set of resources.

54. The first device of claim 41, wherein the indication of the first and the second sets of resources is included in, or excluded from, a first stage sidelink control information.

55. The first device of claim 41, wherein the sub-slot transmission is allowed to be performed in the sidelink communication if at least one of condition is satisfied, the at least one of condition comprises at least one of the following:
the first set of resources reserved for the sub-slot transmission has been indicated to a second device in a previous slot prior to the slot associated with the sub-slot transmission, a listen before talk process for the sub-slot transmission is successful, or
no transmission using a full-slot frame structure is detected in the slot at the first device.

56. The first device of claim 55, wherein the first device comprises a transmitter in the sidelink communication, and wherein the second device comprises a receiver in the sidelink communication.

57. A method comprising:
determining a first set of resources reserved for a sub-slot transmission, wherein the first set of resources reserved for the sub-slot transmission is reserved in a same slot within which a second set of resources is reserved for a full-slot transmission;
preparing a transport block for the full-slot transmission and/or the sub-slot transmission;
performing a sidelink transmission using the sub-slot transmission when listening before talk fails for the full-slot transmission in the same slot.

58. The method of claim 57, further comprising:
determining a transport block size for the transport block prepared for the full-slot transmission and the sub-slot transmission, wherein the full-slot transmission and the sub-slot transmission use the same transport block size.

59. A non-transitory computer readable medium comprising program instructions for causing an apparatus to perform:
determining a first set of resources reserved for a sub-slot transmission, wherein the first set of resources reserved for the sub-slot transmission is reserved in a same slot within which a second set of resources is reserved for a full-slot transmission;
preparing a transport block for the full-slot transmission and/or the sub-slot transmission;
performing a sidelink transmission using the sub-slot transmission when listening before talk fails for the full-slot transmission in the same slot.

60. The non-transitory computer readable medium of claim 59, further comprising program instructions for causing the apparatus to perform:
determining a transport block size for the transport block prepared for the full-slot transmission and the sub-slot transmission, wherein the full-slot transmission and the sub-slot transmission use the same transport block size.
